(19) United States
(12) Patent Application Publication
(10) Pub. No.: US 2006/0115558 A1
(43) Pub. Date: Jun. 1, 2006

(54) Method of production and control of animal derived food products and derivatives thereof

(76) Inventor: Jean-Claude Lamothe, Drummondville (CA)

Correspondence Address: OGILVY RENAULT LLP, 1981 MCGILL COLLEGE AVENUE, SUITE 1600, MONTREAL, QC, H3A2Y3, CA

(21) Appl. No.: 10/917,456

(22) Filed: Nov. 30, 2004

(51) Int. Cl. A23L 1/216

(52) U.S. Cl. 426/96

(57) ABSTRACT

A method of production and control of animal derived food products, for example milk rich in omega-3 isomers by a commercial entity is herein described. The method comprises providing one or more milk producers with a feed formula to feed cows under set control parameters to produce from at least some of the cows milk having omega-3 fatty acids. A computer network access code is provided to the milk producers for access to a central computer of the principal commercial entity. The computer has stored information memory banks associated with each of the access codes. Feed is provided commensurate with the feed formula to each of the producers and data is stored representative of feed types and quantities delivered to particular ones of the milk producers in the information memory banks of these producers. The milk delivered to the commercial entity by the milk producers is analyzed and resulting omega-3 data, as well as other data, is stored in the information memory banks associated with the milk producers and this data is accessible only to the producer and the commercial entity. The information memory bank includes a monetary value of the omega-3 milk depending on the resulting omega-3 data. The method is also applicable to the production of many other food products produced under control to achieve a superior quality food product for the consumer.

### TECHNICAL FIELD

The present invention relates to a method of production and control of animal derived food products and derivatives thereof, whereby to commercialize such food products in a controlled environment. The present invention concerns the production of omega-3 milk, but should not be limited thereto as it applies to many other animal derived food products.

### BACKGROUND ART

In an attempt to provide food products such as milk or eggs rich in omega-3 isomers. Certain milk producers have concocted a cocktail to commercialize a milk product comprised of regular milk, linseed oil and other supplements. When regular milk is mixed with linseed oil, it produces an odor not conducive to milk, and in order to eliminate this odor additives are added. This milk is modified to the point that it can no longer be identified as milk, but as a milk drink. Usually, such drink would utilize a trademark giving the impression that the drink is milk, when in fact it is not milk produced directly from cows. There is a need to provide such products, but derived directly from animals. This requires constant control of the feed and monitoring of the food product.

With milk products and derivatives, such as butter, ice cream, etc., there is provided fats and fatty acids which are important to our well-being, and particularly polyunsaturated fats containing omega-3 and omega-6 fatty acids. Linolenic acid (omega-6) and alphalinolenic acid (omega-3) are two fatty acids of the polyunsaturated fats. They are said to be essential, as they cannot be synthesized by the organs, and must therefore be consumed in foodstuff. These are so essential that the proper function of the brain, the hormone system and the immune system, as well as the cardiovascular system, depends upon these acids. They are major constituents of the human body.

There are principally two sources of omega-3 fatty acids, namely, vegetables and fish. Sources of alphalino-lenic acids can be found in linseeds and linseed oils, soya and canola oil. It has been found that, by feeding cows a special diet of a mixture of linseeds and other feed products, cows (depending on their genetics) can produce milk that is rich in omega-3. Recent studies have shown that the human body requires approximately 1.6 g per day of omega-3 fatty acids for men, and 1.1 g per day for women. The ratio of omega-6/omega-3 is too high in North America, and the share of linolenic acid can be augmented by consuming linseed oil, soya and canola. The omega-3 acids are not only insufficient in the foodstuff, but the excess of omega-6 would affect its utilization. Contrary to omega-3 fatty acids, the omega-6 acids are pro-inflammatory, pro-aggregate and vasoconstrictors. An ideal diet must include omega-3 from vegetables and seafood. The ideal ratio of omega-6 to omega-3 is still unknown, and certain research entities favor a ratio of 1:2 (omega-6/omega-3). Others believe that a ratio of 4:1 is more realistic.

It has been found that omega-3 polyunsaturated fats prevent cardiovascular diseases, and that it favors a lower blood pressure. It also has beneficial effects on diabetics, as well as certain cancers such as colon and breast cancer. Among the fatty acids, omega-3 acids are those that have a greater influence on the immune system. Numerous research has been done on animals and humans that shows clearly the anti-inflammatory effects of fatty acids and, therefore, such is prescribed to treat inflammatory diseases such as rheumatoid arthritis and inflammatory diseases of the intestine.

Studies have also shown that, by introducing linseed grains in the diet of animals, this augmented the quantity of omega-3 fatty acids in the animals' milk, and consequently transmitted to the human body when consumed. Certain studies have also shown that the quantities of omega-3 fatty acids has doubled in animals without changing the feed habits of the animals that were studied. This drastic change in omega-3 fatty acids was obtained without noticing any negative or adverse effects on the animals, and the lipidic balance of the animals seems to have improved. By feeding cows a special diet with feedstock that favors the production of omega-3 in milk, an excellent source of foodstuff can be made available to provide omega-3 acids to the population.

### SUMMARY OF INVENTION

It is therefore a feature of the present invention to provide a method of production and control of animal derived food products of superior quality and derivatives thereof, whereby to produce such products of superior quality and make it available to the public on a large scale.

Another feature of the present invention is to provide a method of production and control of animal derived food products whereby producers of such products can derive financial benefits from the production thereof and wherein the animals are fed a special diet and which has side effects that are more beneficial to the animal by increasing its health and lifespan and increasing production, as well as reproduction, of such animal.

Another feature of the present invention is to provide a method of production and control of animal derived food products and derivatives thereof, and wherein the producers are provided access to the analysis of its product, and are integrated in a computerized system controlled by a principal entity and which favors the maintenance of a quality product, as well as the well-being of its animals.

According to the above features, from a broad aspect, the present invention provides a method of production and control of animal derived food products by a principal commercial entity. The method comprises providing one or more producers of such food products with a feed formula to feed animals under set control parameters to produce from at least some of the animals a food product having a beneficial quality to consumers. The producers are provided a computer network access code whereby to access a central computer of a principal commercial entity, which has stored information memory banks associated with each of the access codes of producers. Feed is provided to the producers that is commensurate with a predetermined feed formula, and data is stored in the information memory banks representative of the feed formula and quantities delivered to the particular ones of the producers. The food product delivered to the commercial entity by the producers, and resulting quality food data of such food is stored in the information memory banks associated with the producers. The quality food data of each bank is accessible only to the access code associated with the bank of a particular producer and the principal commercial entity. A monetary value of the quality food delivered by the producers to the principal entity is inputted into their information memory bank, and this monetary value is dependent on the resulting quality food data.

### BRIEF DESCRIPTION OF DRAWINGS

A preferred embodiment of the present invention will now be described with reference to the accompanying drawings in which:

FIG. 1 is a block diagram illustrating the method of production and control of the present invention as applied to an omega-3 milk food product by a commercial entity and a plurality of milk producers; and

FIG. 2 is a simplified table showing a computer screen display of an information memory bank associated with a milk producer.

### DESCRIPTION OF PREFERRED EMBODIMENT

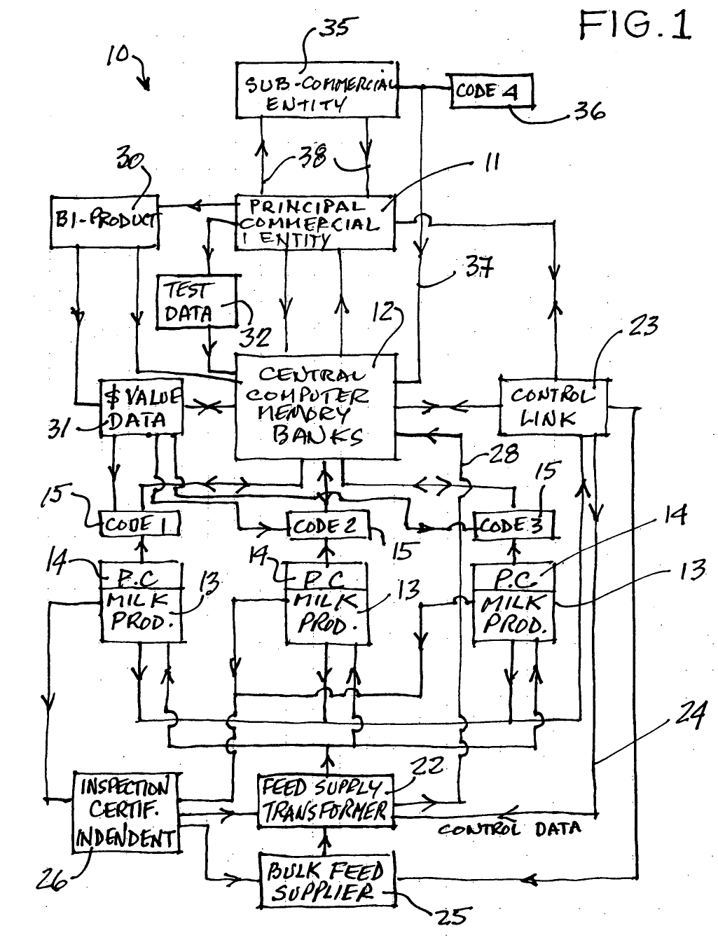

The present invention relates to a method of production and control of animal derived food products and derivatives thereof having a particular beneficial nutritious value to the consumer. Examples of such food products include milk, butter, cheese, eggs, chicken, beef, pork, rabbit and many other animal derived food products. The description that follows illustrates an application for the production of milk rich in omega-3 isomers. Referring now to the drawings, and more particularly to FIG. 1, there is shown generally at 10 the method of production and control of milk rich in omega-3 isomers by a principal entity 11. The principal entity 11 has a central computer 12 containing memory banks associated with each of one or more, and ideally a plurality, of milk producers 13. The milk producers 13 are provided with a PC 14 for communicating with the central computer memory banks, and this is done by each milk producer having an access code 15 for accessing a proprietary information memory bank associated with the milk producer.

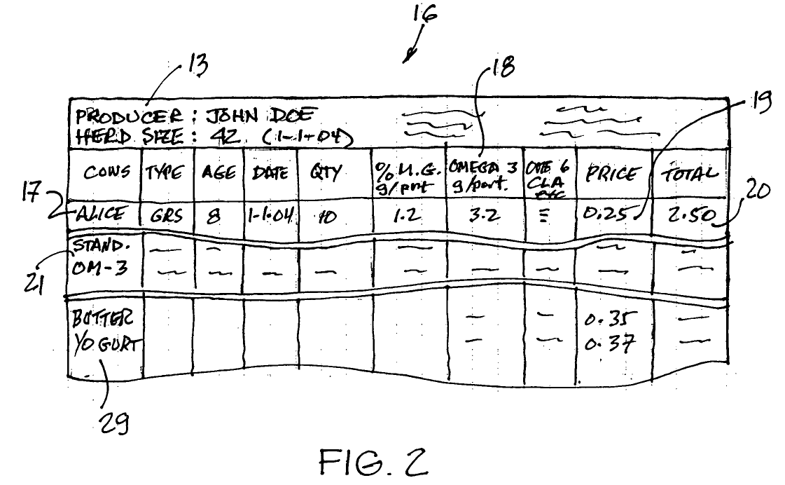

A typical example of a stored information memory bank 16 is illustrated in FIG. 2. This stored information memory bank identifies the milk producer 13 and an analysis section containing analyzed milk data of each cow in its herd. The cow is, for example, identified by its name at 17, its type and age, and the date at which a sample shipment of milk was delivered to the principal entity 11 for analysis. It also includes certain properties contained in the milk sample(s) which was analyzed by the principal commercial entity. These milk samples are analyzed only after a predetermined period of time after the cows have been feed a linseed grain feed mixture. In particular, the present invention is concerned with the analysis of the quantity of omega-3 polyunsaturated fatty acids contained in the milk, and this is displayed in column 18. Depending on the quantities of these omega-3 acids, a price for the quality of the milk is established at that particular date and is displayed in column 19. Column 20 displays the price to be paid to the particular producer for the milk delivered by each specific cow. From this analytical data, the producer can form a herd which gives the best omega-3 value. After a herd is formed, the producer can have his cows reanalyzed from time to time, depending on omega-3 data attributed to his herd.

It has been found that in a herd of milk-producing cows, all of which are fed a specific diet, some cows will produce better omega-3 milk than others. In fact, it has been observed that some cows with the same diet do not produce milk that is rich in omega-3 isomers (fatty acids), and this is most likely due to the genetics of the cow. After the herd has been analyzed, the producer can then separate the cows that produce the desired omega-3 milk from those that do not, and eventually milk collected from the herd of omega-3 cows will be delivered in batch form to the principal commercial entity, and this will appear on the information memory bank 16 under a column identified as “Omega-3.” Accordingly, this stored information memory bank contains a classification of each cow of the herd of the producer, and such classification can be modified or analyzed from time to time by providing samples of the milk produced by such herd to the principal commercial entity. This data also provides to the milk producer an identity of those cows in its herd that are best producers of milk rich in omega-3 isomers, and these can be bred to produce offsprings that may also be high producers of milk rich in omega-3 fatty acids, and the object of the producer is to increase the quality of the omega-3 milk displayed in column 21 of his information memory bank, whereby to obtain a better price for that milk.

TABLE 1
Profile of fatty acids in milk samplings
Samples No. 1 and No. 2 from different herds

| | Quantity (%) | Quantity (%) |
|---|---|---|
| Fatty Acids | Sample No. 1 | Sample No. 2 |
| C4:0 | 4.64 | 5.52 |
| C6:0 | 2.32 | 2.24 |
| C8:0 | 1.50 | 1.31 |
| C10:0 | 3.02 | 2.36 |
| C12:0 | 3.39 | 2.59 |
| C14:0 | 11.04 | 9.26 |
| C14:1 | 0.88 | 0.80 |
| C15:0 | 1.18 | 0.91 |
| C16:0 | 24.24 | 26.45 |
| C16:1 | 0.87 | 1.25 |
| C17:0 | 0.46 | 0.46 |
| C18:0 | 13.10 | 13.16 |
| C18:1 trans | 6.10 | 4.13 |
| C18:1 cis | 23.62 | 26.12 |
| C18:2 (omega-6) | 1.78 | 2.24 |
| C18:3 (omega-3) | 0.99 | 0.56 |
| ALC | 0.78 | 0.62 |
| C20:5 (omega-3) | 0.08 | 0.06 |
| C22:5 (omega-3) | 0.21 | 0.18 |
| Total omega-3 | 1.28 | 0.80 |

Referring to table 1, there is shown the results of analysis of two different milk samples from cows of different herds fed two different feed formulas. It demonstrates over that it is possible to control the quantity of omega-3 isomers (fatty acids) in milk. The ideal quantity of omega-3 isomers is a percentage between about 0.10 to 0.20/250 ml. The feed formula is based on a mixture of various ingredients including soya and linseed. The formula also needs to be controlled and varied dependent on the seasons. For example, when cows grase outside during summer months, the grass is very nutritious, but not so when fed inside during winter months. Accordingly, it is important to monitor the milk periodically and to adjust the supply of feed to the producers to try to maintain a substantially constant milk supply which contains omega-3 isomers within a desirable range. This feed control diet also increases the ALC % in the milk.

TABLE 2
Results of ALC and omega analysis

| Sample | Date | Fat | Protein | SNG | ALC (mg/g) | Omega-3 % | Omega 6 % |
|---|---|---|---|---|---|---|---|
| Farm 1 | Dec. 10, 2003 | 3.78 | 3.49 | 9.05 | 4.5 | 0.57 | 2.05 |
| Farm 2 | Dec. 10, 2003 | 2.95 | 3.13 | 8.69 | 25.2 | 0.54 | 3.32 |
| Farm 3 | Dec. 10, 2003 | 3.29 | 3.07 | 8.69 | 7.7 | 0.64 | 4.07 |
| Farm 1 | Apr. 08, 2004 | 3.56 | 2.95 | 8.55 | 5.40 | 0.69 | 3.30 |
| Farm 2 | May 18, 2004 | 3.17 | 3.14 | 8.99 | 7.80 | 1.28 | 1.78 |
| Farm 3 | May 12, 2004 | 3.65 | 3.20 | 8.78 | 6.20 | 0.80 | 2.24 |

Table 2 shows a further experimental analysis of milk from three different farms where the cows were subjected to a special feed diet. The experiments were conducted from Dec. 10, 2003 to April and May of 2004. Experiments show, particularly with Farm 2, that the omega-3 isomers were increased from 0.54 to 1.28 grams/100 grams.

In order for a herd of cows to produce omega-3 milk, it is essential that the herd be fed feed that is rich in linseeds, and this feed is commensurate with a specific formula. The feed must also be gradually added to the herd in predetermined amounts before the herd can start producing omega-3 milk. The amount of feed delivered to a milk producer is commensurate with the size of its herd and the production thereof, and this data is stored in the information memory bank such that the producer is aware of the quantities of feed delivered to him at various intervals, whereby to analyze the consumption thereof by its herd. Accordingly, a feed supplier 22 is designated to supply the milk producers 13. The feed supplier 22 inputs the delivered information into the central computer memory bank through the computer link 28. The central computer provides information to a control link 23, which feeds data through link 24 to the feed supply transformer 22, and also to a bulk feed supplier 25. The bulk feed supplier supplies seeds to the transformer, which integrates it into a mixture with other feedstock rich in linseed, soya and many other products, such as canola, etc. The importance of the feed supplier transformer feeding information into the central computer, is that this information is used to regulate the producers.

Each of the milk producers 13 who has qualified as an omega-3 milk supplier to the principal commercial entity is then certified by an independent agency 26, who may be provided a report by the principal commercial entity. Regular inspection of the milk producer by the agency 26 assures its certification. Accordingly, the milk producers also form part of an accredited association, certifying them as omega-3 milk producers. Similarly, the feed supply transformer, as well as the bulk feed supplier, have an accreditation by the independent association 26, whereby their feed can be labeled with a logo identifying their membership in the association and the quality of the feedstock for omega-3 milk-producing cows.

The principal commercial entity 11 also utilizes the milk produced by its milk producers 13 for the production of byproducts 30. These byproducts may include milk, aromatic milk, cheeses, cream, ice cream, yogurts, etc. These byproducts fetch a higher price on the market and, accordingly, the producers 13 are paid a higher price for the transformation of their omega-3 milk for use in these products, and this is also inputted into the stored information memory banks 16, as shown at 29 in FIG. 2, which is accessible to the milk producers. The dollar value data 31 is therefore derived from the byproducts, as well as the milk sales by the principal commercial entity. As shown in FIG. 1, the test data block 32 represents all of the milk tests effected by the principal commercial entity and inputted into the central computer information memory banks.

Of course, it would not be practical for a principal commercial entity to cover a very large territory due to the fact that milk has to be transported to dairies. However, the byproducts 30 have a much longer lifespan than milk for drinking, and the commercial territory of the principal commercial entities may be expanded for byproducts. It is, therefore, necessary in the method of production to establish sub-commercial entities 35 in non-conflicting territories where it is commercially impractical to deliver milk due to large distances. Accordingly, a sub-commercial entity is set up in a network, as shown in FIG. 1, and information on the sub-commercial entity 35 is inputted into the central computer memory banks under separate access codes 36, wherein the central computer memory information bank relating to the sub-commercial entity 35 and his milk producers is accessible by the sub-commercial entity. It is also accessible by the principal commercial entity. Transactions between the sub-commercial entity and the principal commercial entity are established through the computer link 37 or a direct communication link 38 between these commercial entities 11 and 35.

It is pointed out that, for a milk producer to be certified as an omega-3 milk producer, there are various parameters that have to be met, and each of these producers is provided with a manual establishing certain criteria such as farm cleanliness, respect for the animals, the supply and administration of the feedstock, etc. Accordingly, the well-being of the animal will improve in this system.

As previously described, it is within the ambit of the present invention to cover any obvious modifications of the preferred embodiment described herein, provided such modifications fall within the scope of the appended claims. The present invention is applicable to the production of many other animal derived food products and should not be restricted to a preferred embodiment described herein.

1. A method of production and control of animal derived food products by a principal commercial entity, comprising the steps of:
i) providing one or more producers of said food products with a predetermined feed formula to feed animals under set control parameters to produce from at least some of said animals a food product having a beneficial quality to consumers;
ii) providing a computer network access code to each said one or more producers to access a central computer of said principal commercial entity, said computer having stored information memory banks associated with each said access code;
iii) providing feed commensurate with said feed formula to each said one or more producers and storing data representative of feed types and quantities of feed delivered to particular ones of said producers in associated ones of said information memory banks for storage therein;
iv) analyzing food products delivered to said commercial entity by said producers and storing resulting analyzed food data of said analyzed food products in said information memory bank associated with each said producers, said data of each said memory banks being accessible only to said access code associated therewith by said producer and said principal commercial entity; and
v) inputting in each said information memory banks a monetary value of said food products dependent on said resulting data.

2. A method as claimed in claim 1 wherein said animal derived food products is milk rich in omega-3 isomers, said producers being milk producers, said data being omega-3 isomer data.

3. A method as claimed in claim 2, wherein said step (i) comprises establishing said set parameters in dependence with cow herd size and cow profile, and establishing a consumption rate of said at least some of said cows until a desired omega-3 isomer data is obtained from said step (iv).

4. A method as claimed in claim 3, wherein aid desired omega-3 isomer data is stored in said information memory bank associated with said at least some of said cows of said producer, said information memory banks having a plurality of said cow profiles stored therein.

5. A method as claimed in claim 4, wherein said monetary value of said omega-3 milk is determined with each said cow profile stored in said central computer information banks and accessible only to said access code of a proprietary milk producer.

6. A method as claimed in claim 5, wherein said monetary value is further dependent on byproducts use of quantities of said omega-3 milk provided by said milk producers.

7. A method as claimed in claim 3, wherein said cow profile includes a cow type and identification name/code, cow age, cow production capacity and reproduction data.

8. A method as claimed in claim 2, wherein said feed formula comprises linseed grain in predetermined quantities and mixed with other animal feed, said linseed grain augmenting the production of fat polyunsaturated acids.

9. A method as claimed in claim 2, wherein there is further provided sub-commercial entities, each comprising the steps (i) to (iv) to associated groups of one or more milk producers, and feeding dollar value data to said central computer in a sub-commercial entity information memory bank accessible only by an access code from said sub-commercial entity and said principal commercial entity.

10. A method as claimed in claim 9, wherein said principal commercial entity has a control access code to all said information memory banks of said sub-commercial entities and said feed supply transformer(s) and feed bulk supplier(s) of said sub-commercial entities.

11. A method as claimed in claim 6, wherein said byproducts used are omega-3 milk byproducts including but not limited to butter, cheese, cream, ice cream and yogurt.

12. A method as claimed in claim 2, wherein said step (iv) comprises analyzing milk samples produced by individual ones or designated ones of cows of a herd of said milk producer, inputting personal cow data into said information memory bank representative of omega-3 fatty acids and other data obtained from said samples analyzed and pertaining to each said cow to establish a profile of said herd of cows of said milk producer.

13. A method as claimed in claim 12, wherein there is further provided the step of periodically analyzing further milk samples of designated cows of a herd of omega-3 cow producers, and modifying said personal cow data in accordance with said further milk samples.

14. A method as claimed in claim 12, wherein there is further provided the step of modifying data of said herd of cows dependent on addition of cows to or subtractions of cows from said herd.

15. A method as claimed in claim 2, wherein there is further provided the step of certifying said milk producers and inspecting said producers to verify that said set parameters are being abided by.

16. A method as claimed in claim 3, wherein said desired omega-3 isomer data is within the range of from about 0.10 to 0.20 grams/250 ml.
